(19) United States
(12) Patent Application Publication
(10) Pub. No.: US 2015/0109133 A1
(43) Pub. Date: Apr. 23, 2015

(54) DISPLAY CONTROL DEVICE, DISPLAY CONTROL METHOD, DISPLAY CONTROL PROGRAM, AND MOBILE TERMINAL

(71) Applicant: Sony Corporation, Tokyo (JP)

(72) Inventor: Alexis Andre, Tokyo (JP)

(73) Assignee: Sony Corporation, Tokyo (JP)

(21) Appl. No.: 14/395,264

(22) PCT Filed: Apr. 19, 2013
(86) PCT No.: PCT/JP2013/002653

§ 371 Date: Oct. 17, 2014

(30) Foreign Application Priority Data
Apr. 27, 2012 (JP) 2012-103428

(51) Int. Cl. G08B 5/36

(52) U.S. Cl. CPC G08B 5/36
USPC 340/657

(57) ABSTRACT

An apparatus may include a control unit to control display of at least one first mark representing a power generating unit and a second mark representing a power storage unit and change of an indication display between the first mark and the second mark according to an amount of power supplied from the power generating unit to the power storage unit.

### CROSS-REFERENCE TO RELATED APPLICATIONS

The present application claims priority from Japanese Patent Application JP 2012-103428 filed in the Japan Patent Office on Apr. 27, 2012, the entire contents of which is hereby incorporated by reference.

### TECHNICAL FIELD

The present disclosure relates to a display control device, a display control method, a display control program, and a mobile terminal.

### BACKGROUND ART

In recent years, “visualization” of an amount of electric power generated by renewable energy has been proposed. For example, PTL 1 discloses a technique of displaying shapes of flowers and changing the number of the lighting flowers in accordance with an amount of electric power generated by renewable energy.

### CITATION LIST

### Patent Literature

PTL 1: Japanese Unexamined Patent Application Publication No. 2011-160606

### SUMMARY

### Technical Problem

When the display disclosed in PTL 1 is employed, a user should recognize the display system in which the number of lighting flowers is changed in accordance with an amount of generated electric power in advance. If the user does not recognize the display system, the number of lighting flowers is meaninglessly changed, that is, the display system is meaningless.

It is desirable to provide a display control device, a display control method, a display control program, and a mobile terminal which attain “visualization” of flows of electric power by a display system different from general display systems.

### Solution to Problem

According to an embodiment of the present disclosure, an apparatus may include a control unit to control display of at least one first mark representing a power generating unit and a second mark representing a power storage unit and change of an indication display between the first mark and the second mark according to an amount of power supplied from the power generating unit to the power storage unit.

According to an embodiment of the present disclosure, a method may include controlling, by a processor, display of at least one first mark representing a power generating unit and a second mark representing a power storage unit and change of an indication display between the first mark and the second mark according to an amount of power supplied from the power generating unit to the power storage unit.

According to an embodiment of the present disclosure, a non-transitory recording medium may be recorded with a program executable by a computer. The program may include controlling display of at least one first mark representing a power generating unit and a second mark representing a power storage unit and change of an indication display between the first mark and the second mark according to an amount of power supplied from the power generating unit to the power storage unit.

According to an embodiment of the present disclosure, an apparatus may include a control unit to control display of at least one first mark representing a power storage unit and a second mark representing a power consumption unit and change of an indication display between the first mark and the second mark according to an amount of power from the power storage unit consumed by the power consumption unit.

### Advantageous Effects of Invention

Accordingly, “visualization” of flows of electric power may be attained by a display system different from general display systems.

### BRIEF DESCRIPTION OF DRAWINGS

FIG. 1 is a diagram illustrating a configuration of a system.

FIG. 2 is a diagram illustrating first display.

FIG. 3 is a diagram illustrating change of the first display.

FIG. 4 is a diagram illustrating a display state of the first display.

FIG. 5 is a diagram illustrating another display state of the first display.

FIG. 6 is a diagram illustrating still another display state of the first display.

FIG. 7 is a diagram illustrating second display.

FIG. 8 is a diagram illustrating change of the second display.

FIG. 9 is a diagram illustrating a configuration of a mobile terminal.

FIG. 10 is a diagram illustrating third display.

FIG. 11 is a diagram illustrating a first modification of the first display.

FIG. 12 is a diagram illustrating a second modification of the first display.

FIG. 13 is a diagram illustrating a third modification of the first display.

FIG. 14 is a diagram illustrating a fourth modification of the first display.

FIG. 15 is a diagram illustrating a fifth modification of the first display.

### DESCRIPTION OF EMBODIMENTS

Embodiments of the present disclosure will be described hereinafter with reference to the accompanying drawings. The description will be made in the following order.

### 1. First Embodiment

### 2. Second Embodiment

### 3. Third Embodiment

### 4. Modifications

Note that the embodiments described below are merely preferable examples of the present disclosure and the present disclosure is not limited to these embodiments.

### 1. First Embodiment

### System Configuration

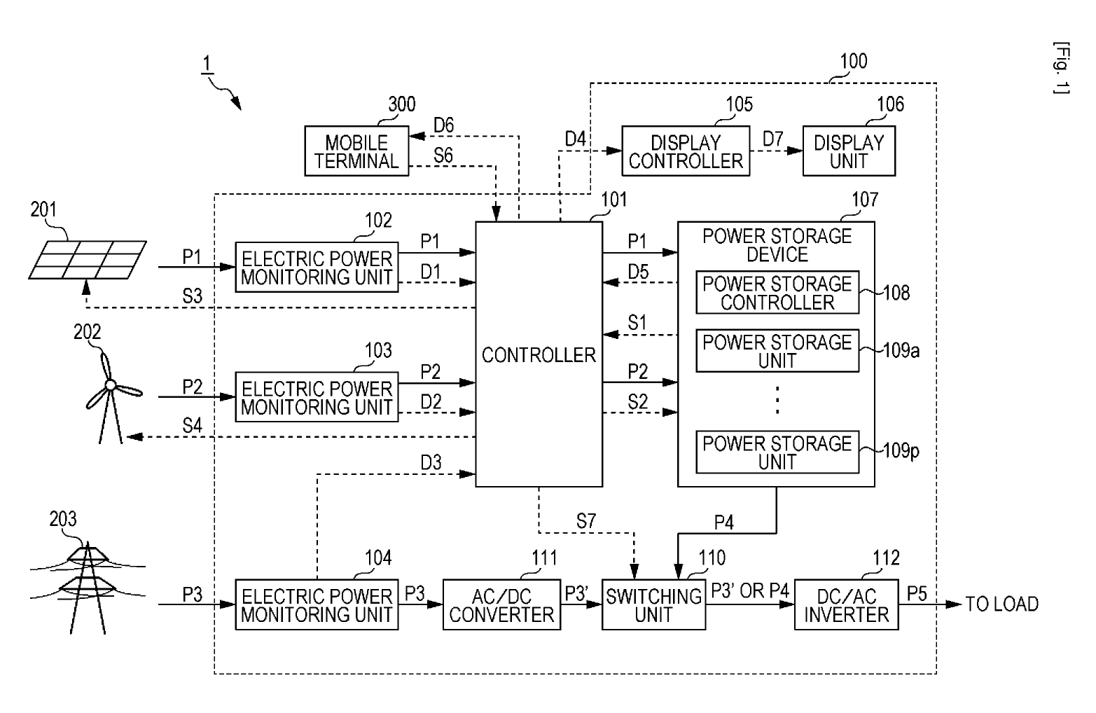

A system configuration according to a first embodiment of the present disclosure will be described with reference to FIG. 1. Note that configurations of systems in second and third embodiments described below are the same as a configuration of a system 1 illustrated in FIG. 1. Arrow marks of solid lines in FIG. 1 illustrate flows of electric power and arrow marks of dotted lines illustrate flows of data and control signals.

The system 1 at least includes a display control device 100. The display control device 100 is installed at homes, companies, laboratories, universities, stations, and the like.

The display control device 100 is connected to a power generation unit which generates electric power using surrounding energy. In FIG. 1, a solar power generation apparatus 201 which generates electric power using solar power and a wind power generation apparatus 202 which generates electric power using wind power are illustrated as power generation units. The solar power generation apparatus 201 is schematically illustrated as a solar panel to which solar light encounters. The solar power generation apparatus 201 has general components such as a power conditioner in addition to the solar panel. The wind power generation apparatus 202 is schematically illustrated as a windmill rotated by wind power. The wind power generation apparatus 202 has general components such as a motor in addition to the windmill.

Solar power generation methods may be classified according to material (such as silicon solar cells and compound solar cells) or configuration types (such as bulk type and thin film type). However, the solar power generation apparatus 201 is not limited to specific material and a specific configuration. Wind power generation methods may be classified according to shapes of windmills (blades) or driving control methods. However, the wind power generation apparatus 202 is not limited to a specific shape of a windmill or a specific driving control method.

The power generation unit is not limited to the solar power generation apparatus and the wind power generation apparatus and may be a biomass power generation unit using biomass. Furthermore, the power generation unit is not limited to a large-scale power generation unit but may be a power generation unit which generates a small amount of electric power. The surrounding energy is not limited to the solar power (sunlight) and the wind power but may be heat, vibration, electric waves, a temperature difference, or an ion concentration difference.

The display control device 100 is connected to a power system 203 (hereinafter referred to as a “grid” where appropriate). In FIG. 1, the grid 203 is schematically illustrated as a power line. The grid 203 includes general components such as a transformer in addition to the power line. Electric power supplied from the grid 203 is generated by nuclear power generation, thermal power generation, and hydroelectric power generation. The electric power supplied from the grid 203 is consumed (used) by loads.

The display control device 100 is capable of communicating with a mobile terminal 300, for example. The mobile terminal 300 performs display in accordance with data transmitted from the display control device 100, for example. A configuration of the mobile terminal 300 and processes performed by the mobile terminal 300 will be described in detail in a third embodiment.

### Summary of Display Control System

The display control device 100 included in the system 1 includes a controller 101 serving as a control unit. The controller 101 is connected to power monitoring units 102, 103, and 104. The controller 101 is further connected to a display controller 105. The display controller 105 is connected to a display unit 106. The controller 101 is further connected to a power storage device 107.

The power storage device 107 includes a power storage controller 108 and 16 power storage units 109a to 109p. The number of power storage units is not limited to 16 but may be changed where appropriate. When the power storage units 109b to 109p are not distinguished from one another, the power storage units 109a to 109p are referred to as “power storage units 109” where appropriate. The controller 101 is further connected to a switching unit 110. The switching unit 110 is connected to an AC (Alternating Current)/DC (Direct Current) converter 111 and a DC/AC inverter 112.

Example of Flows of Electric Power

First, an example of flows of electric power in the system 1 will be described.

Electric power P1 generated by the solar power generation apparatus 201 is supplied to the power storage device 107. A certain voltage is generated in accordance with the electric power P1 by a conversion function of the power storage controller 108. The certain voltage is used by one of the power storage units 109. One of the power storage units 109 is recharged by the generated voltage. One of the power storage units 109 which is a target of the recharge is determined under control of the power storage controller 108. For example, one of the power storage units which has the smallest remaining capacity is determined as the power storage unit 109 of the recharging target. One of the power storage units which corresponds to the smallest number of times in which recharge is performed may be determined as the power storage unit 109 of the recharging target. For example, when the electric power P1 is substantially 0 at nighttime, for example, recharge is not performed.

Electric power P2 generated by the wind power generation apparatus 202 is supplied to the power storage device 107. A certain voltage is generated in accordance with the electric power P2 by a conversion function of the power storage controller 108. The certain voltage is used by one of the power storage units 109. One of the power storage units 109 is recharged by the generated voltage. One of the power storage units 109 which is a target of the recharge is determined under control of the power storage controller 108. For example, one of the power storage units 109 which has the smallest remaining capacity is determined as the power storage unit 109 of the recharging target. One of the power storage units which corresponds to the smallest number of times in which recharge is performed may be determined as the power storage unit 109 of the recharging target. Note that, when the electric power P2 is substantially 0 in a windless state, for example, recharge is not performed.

It is not necessarily the case that the power storage unit which is recharged by the voltage supplied in accordance with the electric power P1 and the power storage unit which is recharged by the voltage supplied in accordance with the electric power P2 are the same as each other. For example, in a sunny day with strong wind, the solar power generation apparatus 201 and the wind power generation apparatus 202 generate electric power of a certain amount or more. In this case, the power storage unit 109a may perform power storage in accordance with the voltage supplied in accordance with the electric power P1 and the power storage unit 109b may perform power storage in accordance with the voltage supplied in accordance with the electric power P2. Control of the power storage is performed by the power storage controller 108.

The power storage controller 108 performs control of electric discharge from the power storage device 107. For example, the power storage controller 108 obtains remaining capacities of the power storage units 109 and determines that one of the power storage units 109 which has the largest remaining capacity is a power storage unit 109 of a target of the electric discharge. Electric power P4 of a direct current output from the power storage unit 109 of the discharging target is supplied to the switching unit 110.

Note that the power storage controller 108 is capable of performing bidirectional communication with the controller 101. For example, remaining capacity data D5 which represents a sum of the remaining capacities of the 16 power storage units 109 is supplied from the power storage controller 108 to the controller 101. For example, a notification signal S1 which represents that the power storage device 107 is not capable of performing electric discharge due to lack of the remaining capacities of the power storage units 109 or failure is supplied from the power storage controller 108 to the controller 101.

AC power P3 is supplied from the grid 203 to the AC/DC converter 111. The AC/DC converter 111 temporarily converts the electric power P3 into DC power P3′. The electric power P3′ is supplied to the switching unit 110.

The switching unit 110 selects one of the electric power P3′ and the electric power P4. The selected electric power is supplied to the DC/AC inverter 112. The switching unit 110 is controlled by the controller 101, for example. For example, the controller 101 obtains electric power which is to be consumed by loads, and when the electric power P4 may cover the electric power to be consumed by the loads, the controller 101 controls the switching unit 110 so that the switching unit 110 selects the electric power P4. When an amount of the electric power P4 is smaller than an amount of the electric power to be consumed by the loads, the controller 101 controls the switching unit 110 so that the switching unit 110 selects the electric power P3′.

The electric power P3′ or the electric power P4 is supplied to the DC/AC inverter 112. The DC/AC inverter 112 generates AC power P5 of 100 V (volts), for example, in accordance with the electric power P3′ or the electric power P4. The electric power P5 is supplied to outlets, for example, and further supplied to the loads connected to the outlets.

Note that a power source voltage (5 V, for example) may be generated in accordance with an output of a certain one of the power storage units 109 and may be supplied to the units included in the display control device 100.

### Configuration of Display Control Device

Next, the units included in the display control device 100 will be described. The controller 101 includes a CPU (Central Processing Unit), for example, and controls the units included in the display control device 100. Examples of processes executed by the controller 101 will be described hereinafter.

The controller 101 obtains data D1 representing the electric power P1 generated by the solar power generation apparatus 201 from the power monitoring unit 102. The controller 101 obtains power supply amount data D1′ representing an amount of electric power supplied from the solar power generation apparatus 201 to the power storage device 107 in accordance with the data D1. The power supply amount data D1′ may be the data D1 itself or may be obtained by performing calculation on a value represented by the data D1 taking transmission loss into consideration.

The controller 101 obtains data D2 representing the electric power P2 generated by the wind power generation apparatus 202 from the power monitoring unit 103. The controller 101 obtains power supply amount data D2′ representing an amount of electric power supplied from the wind power generation apparatus 202 to the power storage device 107 in accordance with the data D2. The power supply amount data D2′ may be the data D2 itself or may be obtained by performing calculation on a value represented by the data D2 taking transmission loss into consideration.

The controller 101 obtains data D3 representing the electric power P3 supplied from the grid 203 from the power monitoring unit 104. Since the electric power P3 supplied from the grid 203 is not stored but used by the loads, the data D3 represents an amount of consumption of electric power supplied from the grid 203 (hereinafter referred to as a “power consumption amount” where appropriate). The power consumption amount may be obtained by performing predetermined calculation on the data D3. Note that the data D3 may be referred to as “power consumption amount data D3”.

The data D1, the data D2, and the data D3 are periodically (every five minutes, for example) supplied to the controller 101, for example. Specifically, the data D1, the data D2, and the data D3 obtained at substantially the same timings every five minutes are supplied to the controller 101.

The controller 101 communicates with the power storage controller 108. The communication is performed in accordance with an SMBus (System Management Bus) standard. The controller 101 obtains the remaining capacity data D5 supplied from the power storage controller 108. The remaining capacity data D5 is periodically supplied to the controller 101 at a timing substantially the same as the timing when the data D1 and the like are supplied to the controller 101.

The controller 101 supplies the power supply amount data D1′, the power supply amount data D2′, the power consumption amount data D3, and the remaining capacity data D5 to the display controller 105. The controller 101 performs time division multiplexing on the data, for example, so as to obtain data D4 and supplies the data D4 to the display controller 105.

The controller 101 supplies a switching signal S7 to the switching unit 110 so as to switch electric power selected by the switching unit 110. When the electric power P4 output from the power storage device 107 may cover the electric power to be consumed by the loads, the controller 101 controls the switching unit 110 so that the switching unit 110 selects the electric power P4. When the notification signal S1 is supplied from the power storage controller 108 or when the electric power P4 may not cover the electric power to be consumed by the loads, the controller 101 controls the switching unit 110 so that the switching unit 110 selects the electric power P3′.

The controller 101 may perform other control operations. The controller 101 may supply a control signal S3 to the solar power generation apparatus 201 so that MPPT (Maximum Power Point Tracking) which is an control operation of efficiently extracting an output from solar cells, for example, is executed. The controller 101 may supply a control signal S4 to the wind power generation apparatus 202 so that a control operation of preventing rapid change of an output of the wind power generation apparatus 202 due to a stormy wind or the like is executed. These control operations may be executed by control devices included in the solar power generation apparatus 201 and the wind power generation apparatus 202.

The controller 101 functions as a communication unit, for example, and performs wireless communication with the mobile terminal 300. Examples of the wireless communication include short-range low-power-consumption communication based on an ANT standard, communication based on a “Z-Wave (registered trademark)” standard, communication based on “Zigbee (registered trademark)” standard, communication based on “Bluetooth (registered trademark)” standard, and communication based on “Wi Fi (registered trademark)” which facilitates network formation. The wireless communication is not limited to the communication of the described standards. Communication through the Internet may be performed between the controller 101 and the mobile terminal 300.

The controller 101 periodically (every five minutes, for example) transmits data D6 to the mobile terminal 300 in response to a request signal S6 transmitted from the mobile terminal 300, for example. The data D6 is similar to the data D4, and includes the power supply amount data D1′, the power supply amount data D2′, the power consumption amount data D3, and the remaining capacity data D5.

Other configurations of the display control device 100 will be described. The power monitoring unit 102 obtains the electric power P1 (W (watt)) generated by the solar power generation apparatus 201. The power monitoring unit 102 supplies the data D1 representing the electric power P1 to the controller 101. The electric power P1 generated by the solar power generation apparatus 201 is supplied to the power storage device 107 and stored in a certain one of the power storage units 109. Note that, although not shown, a backflow prevention diode is connected between the solar power generation apparatus 201 and the power monitoring unit 102.

The power monitoring unit 103 obtains the electric power P2 generated by the wind power generation apparatus 202. The power monitoring unit 103 supplies the data D2 representing the electric power P2 to the controller 101. The electric power P2 generated by the wind power generation apparatus 202 is supplied to the power storage device 107 and stored in a certain one of the power storage units 109. Note that, although not shown, a backflow prevention diode is connected between the wind power generation apparatus 202 and the power monitoring unit 103.

The power monitoring unit 104 obtains the electric power P3 supplied from the grid 203. The electric power P3 supplied from the grid 203 is not stored but used by the loads and corresponds to consumed power. The power monitoring unit 104 supplies the data D3 to the controller 101 as the power consumption amount data D3.

The display controller 105 executes predetermined drawing software so that predetermined display is performed in accordance with the data D4. When the display controller 105 operates, display data D7 is generated. The generated display data D7 is supplied to the display unit 106. Note that the function of the display controller 105 may be included in the controller 101.

The display unit 106 includes an LCD (Liquid Crystal Display) panel or an organic EL (Electroluminescence) panel. The display unit 106 performs display in accordance with the display data D7 supplied from the display controller 105. Concrete examples of the display performed in accordance with the display data D7 will be described hereinafter.

The power storage device 107 which is an example of a power storage unit includes the power storage controller 108 and the plurality of power storage units 109. The power storage device 107 includes the 16 power storage units 109 (power storage units 109a to 109p), for example. The power storage controller 108 controls the units included in the power storage device 107. The controller 101 supplies a control signal S2 to the power storage controller 108. The control signal S2 is used to perform switching between on and off of the power storage device 107, for example. The power storage controller 108 operates in accordance with the control signal S2.

The power storage controller 108 includes a step-down DC-DC converter and generates a certain voltage from the electric power P1. The certain voltage is used by one of the power storage units 109. The power storage controller 108 supplies the generated voltage to one of the power storage units 109 having a small remaining capacity, for example, so as to recharge the power storage unit 109. The power storage controller 108 performs a process of ensuring security such as prevention of overcharge at the time of the recharge.

The power storage controller 108 includes a step-down DC-DC converter and generates a certain voltage from the electric power P2. The certain voltage is used by one of the power storage units 109. The power storage controller 108 supplies the generated voltage to one of the power storage units 109 having a small remaining capacity, for example, so as to recharge the power storage unit 109.

The power storage controller 108 includes a step-up DC-DC converter which steps up a voltage of a certain one of the power storage units 109 to an appropriate voltage and outputs the voltage as the DC power P4. The power storage controller 108 sets one of the power storage units 109 having a large remaining capacity as a power storage unit of a discharging target and controls the power storage unit 109 so that the power storage unit 109 performs electric discharge.

The power storage controller 108 monitors remaining capacities of the power storage units 109 and supplies the remaining capacity data D5 representing a sum of the remaining capacities to the controller 101. For example, when the remaining capacities of all the power storage units 109 are smaller than a threshold value, the discharge is stopped and the power storage controller 108 supplies the notification signal S1 representing the stop of the discharge to the controller 101.

The power storage units 109 are constituted by lithium-ion batteries, olivine-type lithium iron phosphate batteries, lead batteries, or NAS batteries. Alternatively, other batteries or electric double layer capacitors may be used.

The switching unit 110 operates in accordance with the switching signal S7 supplied from the controller 101 and selects the electric power P3′ or the electric power P4. The electric power selected by the switching unit 110 is output to the DC/AC inverter 112.

The AC/DC converter 111 converts the AC power P3 supplied from the grid 203 into the DC power P3′. The DC/AC inverter 112 converts the electric power supplied from the switching unit 110 into a voltage of 100 V, for example. An output from the DC/AC inverter 112 is supplied to the loads.

Note that a power storage device may be disposed between the switching unit 110 and the DC/AC inverter 112 so as to prevent instantaneous voltage drop caused by the operation of the switching unit 110. As the power storage device, a secondary battery or an electric double layer capacitor may be used.

### Operation of Display Control Device

An example of operation of the display control device 100 will be described. The controller 101 performs switching between electric power output from the power storage device 107 and electric power supplied from the grid 203 in accordance with the remaining capacities of the power storage units 109 and power consumption so as to supply the electric power to the loads. Note that control of the switching the electric power to be supplied to the loads is not limited to a specific control method but general control methods may be employed.

The controller 101 supplies the data D4 including the power supply amount data D1′, the power supply amount data D2′, the power consumption amount data D3, and the remaining capacity data D5 to the display controller 105. The display controller 105 operates so that predetermined display is performed in accordance with the data D4 and generates the display data D7. The generated display data D7 is supplied to the display unit 106. The display unit 106 performs display in accordance with the display data D7.

Example of Display Based on Display Data

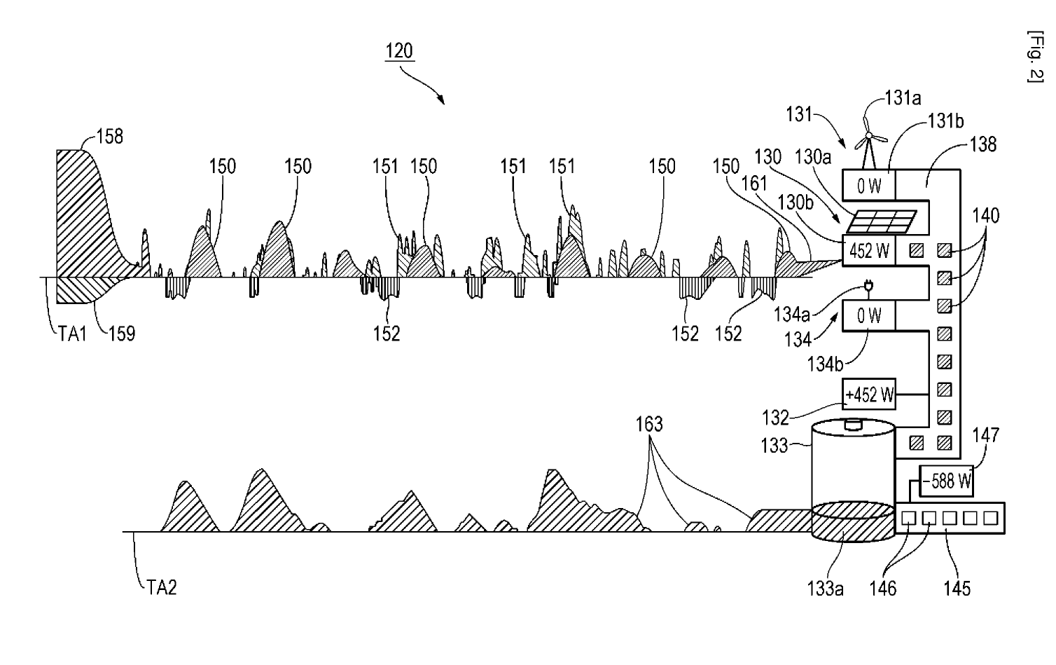

FIG. 2 is an example of display 120 performed in accordance with the display data D7. Content of the display 120 may be changed in a real-time manner or periodically. A process of displaying the display 120 and a process of changing the content of the display 120 in real time are performed under control of the display controller 105. Note that, in the display 120, reference symbols displayed in a number of portions (such as indication blocks described below and marks 150) are assigned to only selected portions so that complication of the drawing is avoided. Furthermore, although directions such as an upward direction, a downward direction, a right direction, and a left direction are described in the following description, the directions are described on the basis of directions of the drawings. Note that the directions are not limited to the directions illustrated in the present disclosure.

A first mark corresponding to a power generation unit is displayed. Since, as the power generation unit, the solar power generation apparatus 201 and the wind power generation apparatus 202 are described as examples, a solar power generation mark 130 corresponding to the solar power generation apparatus 201 and a wind power generation mark 131 corresponding to the wind power generation apparatus 202 are displayed.

The solar power generation mark 130 includes a solar panel mark 130a and a display region 130b which displays a numerical value, for example. In the display region 130b, a numerical value represented by the power supply amount data D1′ (452 W, for example) is displayed. Specifically, an amount of electric power supplied from the solar power generation apparatus 201 to the power storage device 107 is displayed. Since an amount of electric power generated by the solar power generation apparatus 201 is changed from moment to moment according to weather, the numerical value displayed in the display region 130b is also changed.

The wind power generation mark 131 includes a windmill mark 131a and a display region 131b which displays a numerical value, for example. In the display region 131b, a numerical value represented by the power supply amount data D2′ is displayed. Specifically, an amount of electric power supplied from the wind power generation apparatus 202 to the power storage device 107 is displayed. Since an amount of electric power generated by the wind power generation apparatus 202 is changed from moment to moment according to weather, the numerical value displayed in the display region 131b is also changed.

A second mark corresponding to the power storage device 107 is displayed. As an example of the second mark, a battery mark 133 of a battery shape is displayed. In the battery mark 133, a remaining amount indicator 133a which moves upward and downward in the battery mark 133 is displayed. A position of the remaining amount indicator 133a is appropriately determined in accordance with the remaining capacity data D5. When the remaining capacity data D5 is large, the position of the remaining amount indicator 133a is high. When the remaining capacity data D5 is small, the position of the remaining amount indicator 133a is low. The position of the remaining amount indicator 133a is changed in accordance with change of the remaining capacity data D5. The remaining amount indicator 133a is displayed in green, for example.

A third mark corresponding to a grid power is displayed. A grid mark 134 is displayed as an example of the third mark. The grid mark 134 includes a mark 134a of a plug shape and a display region 134b which displays a numerical value, for example. In the display region 134b, a numerical value represented by the power supply amount data D3 is displayed. Note that a sum of the numerical value displayed in the display region 130b, the numerical value displayed in the display region 131b, and the numerical value displayed in the display region 134b which are connected to one another through a connection path 138, which will be described hereinafter, is displayed in a display region 132.

Various indications are displayed in a path which connects the solar power generation mark 130, the wind power generation mark 131, and the battery mark 133. The indications displayed in the path include the connection path 138 and a plurality of indication blocks which move in the connection path 138. The connection path 138 is displayed such that the connection path 138 connects the display region 130b of the solar power generation mark 130, the display region 131b of the wind power generation mark 131, and the battery mark 133 to one another. The connection path 138 is further connected to the display region 134b of the grid mark 134.

A number of indication blocks move in the connection path 138. For example, the solar power generation apparatus 201 generates electric power. As the solar power generation apparatus 201 generates the electric power, the numerical value of the display region 130b is changed and the plurality of indication blocks 140 move toward the battery mark 133 from a portion in the vicinity of the display region 130b. When arriving at the battery mark 133, the indication blocks 140 are removed. The plurality of indication blocks 140 are hatched in the same manner. The indication blocks 140 are rectangles and displayed in yellow, for example. The indication blocks 140 may have other shapes such as circle or may be colored in other colors.

As an amount of electric power supplied from the solar power generation apparatus 201 to the power storage device 107 becomes large, the numerical value of the display region 130b becomes large and a movement speed of the indication blocks 140 becomes high. As the amount of electric power supplied from the solar power generation apparatus 201 to the power storage device 107 becomes small, the numerical value of the display region 130b becomes small and the movement speed of the indication blocks 140 becomes low. The movement speed of the indication blocks 140 may be changed when a power supply amount is changed by 1 W, or the movement speed of the indication blocks 140 may be changed when the power supply amount is changed to be equal to or larger than a threshold value (10 W, for example). As the amount of electric power supplied from the solar power generation apparatus 201 to the power storage device 107 becomes large, a display state of the solar panel mark 130a may be changed. For example, when the power supply amount is 0 or is equal to or smaller than a threshold value, an inside of the solar panel mark 130a is displayed in black. A region included in the solar panel mark 130a which is displayed in white may be changeable. As the power supply amount becomes large, the region displayed in white included in the solar panel mark 130a may be increased. In this way, a state in which an amount of solar light which encounters the solar panel is increased and accordingly the power supply amount is increased is displayed.

Also in the case of the wind power generation, similar display is performed. For example, the wind power generation apparatus 202 generates electric power. As the wind power generation apparatus 202 generates the electric power, the numerical value of the display region 131b is changed and the plurality of indication blocks 141 move toward the battery mark 133 from a portion in the vicinity of the display region 131b in the connection path 138. When arriving at the battery mark 133, the indication blocks 141 are removed. Since the power supply amount of the wind power generation apparatus 202 is 0 W in FIG. 2, the indication blocks 141 are not displayed. The indication blocks 141 are rectangles, for example, and displayed in blue. The indication blocks 141 may have other shapes such as circle or may be colored in other colors.

Since the indication blocks 140 and the indication blocks 141 are displayed in different colors, the indication blocks 140 and the indication blocks 141 may be distinguished from each other in the display. The indication blocks 140 and the indication blocks 141 may be distinguished from each other in the display by displaying the indication blocks 140 and the indication blocks 141 in different shapes. The indication blocks 140 and the indication blocks 141 may be distinguished from each other in the display by displaying the indication blocks 140 and the indication blocks 141 in different colors and different shapes. Change of the movement speeds of the indication blocks 140 and the indication blocks 141 are appropriately set by drawing software or the like.

As the amount of electric power supplied from the wind power generation apparatus 202 to the power storage device 107 becomes large, the numerical value of the display region 131b becomes large and the movement speed of the indication blocks 141 becomes high. As the amount of electric power supplied from the wind power generation apparatus 202 to the power storage device 107 becomes small, the numerical value of the display region 131b becomes small and the movement speed of the indication blocks 141 becomes low. As the amount of electric power supplied from the wind power generation apparatus 202 to the power storage device 107 becomes large, a display state of the windmill mark 131a may be changed. For example, when the power supply amount is 0 or is equal to or smaller than a threshold value, the mark 131a is not rotated. As the power supply amount becomes large, the mark 131a may be rotated at high speed. In this way, a state in which the windmill rotates at high speed as an amount of wind is increased and accordingly the power supply amount is increased is displayed.

Since the indication blocks which may be distinguished from each other move from marks of power generation apparatuses to a battery mark, the power generation apparatuses which supply electric power may be easily recognized by the user. Furthermore, since the indication blocks move, flows of electric power which are not represented only by a numerical value may be displayed. Furthermore, since the movement speed of the indication blocks is changed, for example, change of the power supply amount may be easily recognized by the user. Even when users who do not know the display system see the display 120, the users may easily understand the system displayed in the display 120.

A power supply path 145 which supplies electric power to the loads is displayed so as to extend from the battery mark 133. Indication blocks 146 are displayed in accordance with the electric power consumed by the loads. The indication blocks 146 move in the power supply path 145 as if the indication blocks 146 separate from the battery mark 133. A display region 147 which represents electric power consumed by the loads (588 W, for example) is displayed. A numerical value displayed in the display region 147 is changed in accordance with change of power consumption.

A time axis TA1 is displayed in substantially the center of the display unit 106. On an upper side of the time axis TA1, a fourth mark representing an amount of electric power supplied to a power storage device (the power storage device 107, for example) from a power generation unit (the solar power generation apparatus 201 and the wind power generation apparatus 202, for example) is displayed. For example, on the upper side of the time axis TA1, marks 150 representing an amount of electric power supplied from the solar power generation apparatus 201 to the power storage device 107 and marks 151 representing an amount of electric power supplied from the wind power generation apparatus 202 to the power storage device 107 are displayed. The individual marks 150 and the individual marks 151 are examples of the fourth mark. Specifically, on the upper side of the time axis TA1, energy defined as “energy which does not destroy environment”, “natural energy”, “free energy”, and the like is schematically displayed.

On a lower side of the time axis TA1, a fifth mark representing an amount of consumption of electric power supplied from the grid 203 is displayed. For example, a plurality of marks 152 are displayed on the lower side of the time axis TA1. Specifically, on the lower side of the time axis TA1, energy defined as “energy obtained along with destruction of environment”, “paid energy”, and the like is schematically displayed.

The marks 150 are displayed in yellow which is the same color as the indication blocks 140, for example. The marks 151 are displayed in blue which is the same color as the indication blocks 141, for example. The marks 152 are displayed in red which is the same color as indication blocks 142 which will be described hereinafter, for example. In a portion in the vicinity of a left end of the upper side of the time axis TA1, a mark 158 representing information on an integrated value of power supply amounts is displayed. The mark 158 which is an example of a sixth mark is displayed in green, for example. In a portion in the vicinity of a left end of the lower side of the time axis TA1, a mark 159 representing information on an integrated value of power consumption amounts is displayed. The mark 159 which is an example of a seventh mark is displayed in red, for example.

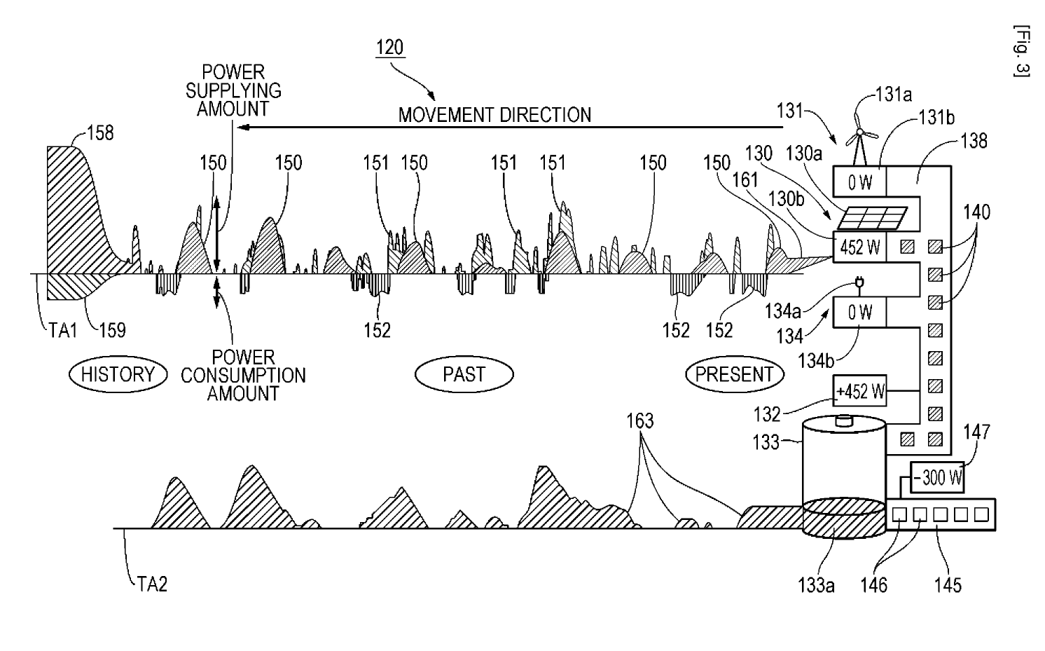

Detailed description will be made with reference to FIG. 3. Heights of the marks 150 and the marks 151 (lengths in a direction substantially orthogonal to the time axis TA1) represent power supply amounts. For example, scale marks may be displayed every 100 W. Intervals between the scale marks may be dynamically changed. For example, when the power supply amount of the wind power generation apparatus 202 is rapidly increased, the scale marks displayed every 100 W may be changed to scale marks displayed every 200 W. Heights of the marks 152 represent amounts of consumption of electric power supplied from the grid 203. Note that indications such as a movement direction, a power consumption amount, past, present, and history are merely used to facilitate the understanding and are not displayed in practice.

To the display controller 105, the power supply amount data D1′ is periodically (every five minutes, for example) supplied from the controller 101. The display controller 105 causes a width of one pixel on the time axis TA1 (a length in parallel to the time axis TA1) to correspond to five minutes and performs display in accordance with the power supply amount data D1′ supplied at a certain timing. A method for displaying the marks 150 is determined in accordance with a drawing program executed by the display controller 105.

An example of a method for displaying the marks 150 will be described. While the solar power generation apparatus 201 generates electric power, a sign 161 of a beam shape is displayed which extends from the solar power generation mark 130. The beam shape includes a shape which spreads in a certain direction from a certain point serving as a starting point. The sign 161 of the beam shape is displayed so as to extend from the solar power generation mark 130 or from a portion in the vicinity of the solar power generation mark 130 serving as a starting point toward a right end of the time axis TA1.

At an end of the sign 161, signs representing heights of the power supply amount data D1′ are successively displayed. When the amount of electric power supplied from the solar power generation apparatus 201 is 0 or is equal to or smaller than a threshold value, the sign 161 of the beam shape is removed and the mark 150 which has a certain area is displayed. The mark 150 moves on the time axis TA1 by one pixel every five minutes, for example. A display scale may not be displayed every five minutes and may be appropriately set. The display scale may be set by the user.

When the mark 150 moves to a portion in the vicinity of the mark 158 of the time axis TA1, the mark 150 disappears as if the mark 150 is absorbed by the mark 158. When the mark 150 disappears, a size of the mark 158 is enlarged by a degree corresponding to a size of the mark 150. The marks 151 and the marks 152 are displayed similarly to the marks 150.

In the display unit 106, power supply amounts for a period of time corresponding to the past one week are displayed by the marks 150, for example. The period of time may be appropriately changed by changing a size of a display region of the display unit 106 and a period of time corresponding to a width of one pixel.

When the sign 161 of the beam shape is displayed and the mark representing to a height corresponding to a power supply amount is displayed, the user may visually recognize an amount of electric power currently generated by a specific power generation unit. Furthermore, since the marks 150 and the marks 151 are displayed as if the marks 150 and the marks 151 move along the time axis TA1, past power supply amounts may be recognized by the user in addition to the current power supply amount. Moreover, the user may recognize, in addition to the power supply amounts, amounts of past and current consumption of electric power supplied from the grid 203. Moreover, the user may recognize an integrated value of power supply amounts for a certain period of time and an integrated value of amounts of consumption of electric power supplied from the grid 203 for the certain period of time.

Referring back to FIG. 2, a time axis TA2 is displayed in a portion in the vicinity of the battery mark 133. A plurality of marks 163 are displayed on the time axis TA2. The marks 163 represent a remaining capacity of the power storage device 107 (a sum of remaining capacities of the 16 power storage units 109, for example) represented by the remaining capacity data D5. The marks 163 move on the time axis TA2 from right to left. Note that, when the remaining capacity of the power storage device 107 is enough and electric power is sold, a mark representing an amount of the sold electric power may be displayed on a lower side of the time axis TA2. A timing of the electric power selling may be displayed. A sign of a beam shape extending from the battery mark 133 may be displayed and thereafter the marks 163 may be displayed.

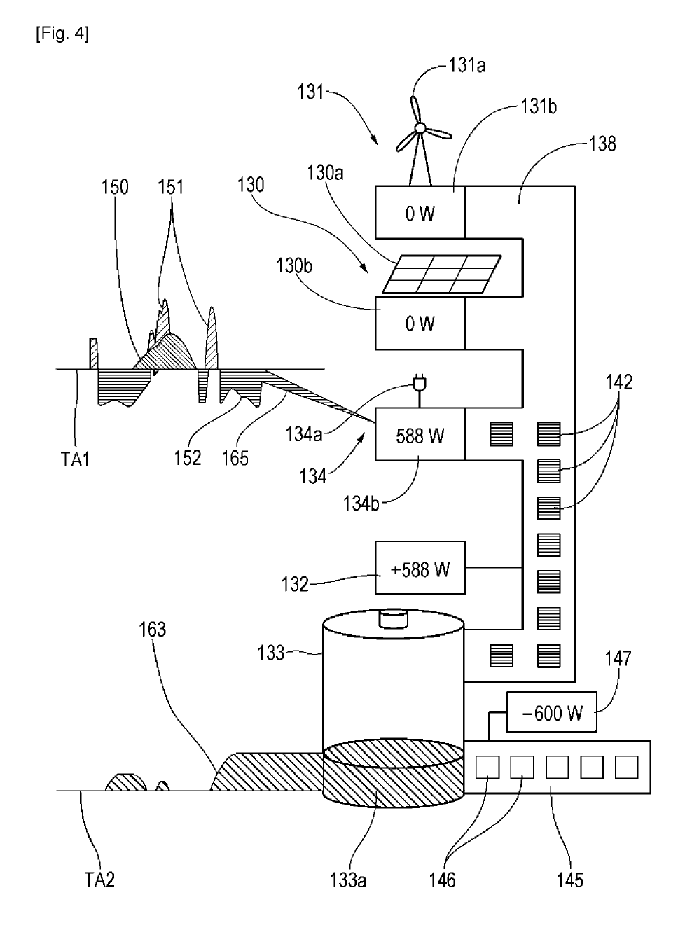

Other examples of the display 120 will be further described. FIG. 4 is a diagram illustrating the display 120 displayed when the electric power P3 supplied from the grid 203 is used. For example, when the remaining capacities of the power storage units 109 are small and it is dead calm at night, the electric power P3 supplied from the grid 203 is used. Note that, in FIG. 4, a portion of the display 120 is displayed in an enlarged manner.

Since the solar power generation apparatus 201 and the wind power generation apparatus 202 do not generate electric power, a numerical value 0 W is displayed in the display region 130b and the display region 131b. Since the electric power P3 supplied from the grid 203 is used, a numerical value (588 W, for example) represented by the power consumption amount data D3 is displayed in the display region 134b. The indication blocks 142 move in the connection path 138 from a portion in the vicinity of the display region 134b toward the battery mark 133. The indication blocks 142 are rectangles, for example, and colored in red which is the same as the color of the marks 152. The larger the power consumption amount becomes, the higher a movement speed of the indication blocks 142 becomes. In this example, the power storage units 109 are not recharged by the electric power P3 supplied from the grid 203. Accordingly, the remaining amount indicator 133a of the battery mark 133 does not move.

Note that a movement speed of the indication blocks 146 which move in the power supply path 145 may become higher as power consumption of the loads becomes large. The indication blocks 146 may be displayed in the same shape and the same color as the indication blocks 142.

A sign 165 of a beam shape is displayed from the grid mark 134 toward the right end of the time axis TA1. From an end of the sign 165, marks representing heights corresponding to power consumption amounts are successively displayed. When a power supply source is switched from the grid 203 to the power storage device 107, a power consumption amount becomes 0 or equal to or smaller than a threshold value. In this case, the sign 165 of the beam shape is removed and the mark 152 having a certain display region is displayed.

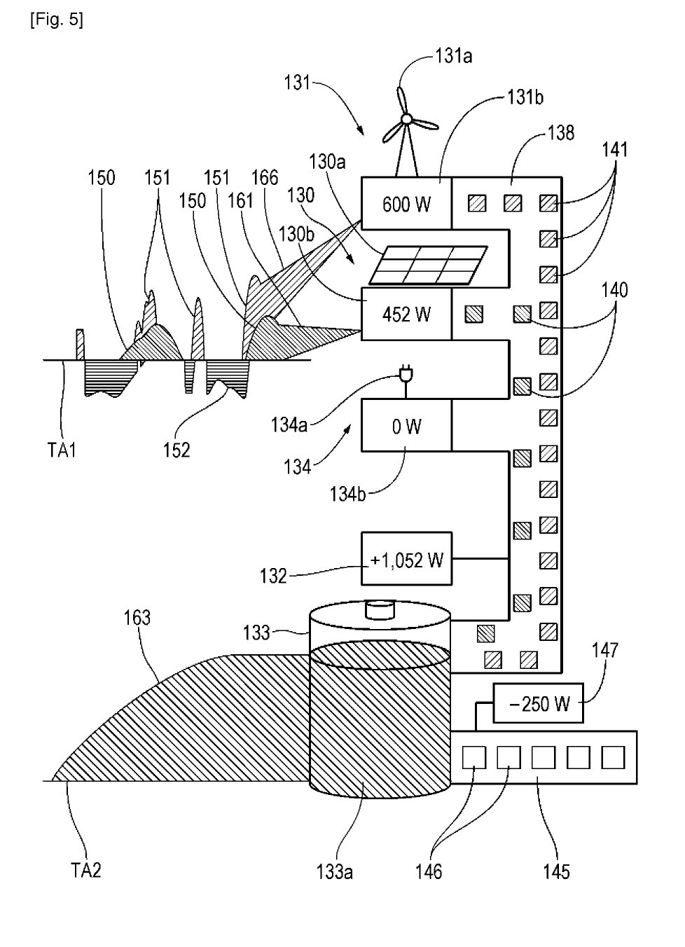

FIG. 5 is a diagram illustrating the display 120 displayed when the solar power generation apparatus 201 and the wind power generation apparatus 202 generate electric power. Note that, in FIG. 5, a portion of the display 120 is displayed in an enlarged manner. A numerical value representing an amount of electric power supplied from the solar power generation apparatus 201 (452 W, for example) is displayed in the display region 130b. The indication blocks 140 move in the connection path 138 from a portion in the vicinity of the display region 130b of the solar power generation mark 130 toward the battery mark 133. Since the solar power generation apparatus 201 generates electric power, the sign 161 of the beam shape is displayed and the marks 150 are displayed on the time axis TA1.

A numerical value representing an amount of electric power supplied from the wind power generation apparatus 202 (600 W, for example) is displayed in the display region 131b. The indication blocks 141 move in the connection path 138 from a portion in the vicinity of the display region 131b of the wind power generation mark 131 toward the battery mark 133. Since the wind power generation apparatus 202 generates electric power, a sign 166 of the beam shape is displayed and the marks 151 are displayed on the time axis TA1.

As described above, the indication blocks 140 and the indication blocks 141 are distinguishable from each other. The indication blocks 140 and the indication blocks 141 move in parallel from a certain portion in the connection path 138. The larger the power supply amount of the solar power generation apparatus 201 becomes, the higher the movement speed of the indication blocks 140 becomes. The smaller the power supply amount of the solar power generation apparatus 201 becomes, the lower the movement speed of the indication blocks 140 becomes. The larger the power supply amount of the wind power generation apparatus 202 becomes, the higher the movement speed of the indication blocks 141 becomes. The smaller the power supply amount of the wind power generation apparatus 202 becomes, the lower the movement speed of the indication blocks 141 becomes.

The movement speed of the indication blocks 140 and the movement speed of the indication blocks 141 may be set in accordance with the amount of electric power supplied from the solar power generation apparatus 201 and the amount of electric power supplied from the wind power generation apparatus 202, respectively. The user may easily recognize the largest power supply amount between the amount of the electric power supplied from the solar power generation apparatus 201 and the amount of electric power supplied from the wind power generation apparatus 202. Furthermore, the user who sees the display 120 indoors may forecast outside weather (for example, fair skies, cloudy skies, strong wind, and dead calm) from the display 120.

When the power supply amount is larger than the power consumption amount, the position of the remaining amount indicator 133a of the battery mark 133 becomes high. Note that, the electric power P1 supplied from the solar power generation apparatus 201 and the electric power P2 supplied from the wind power generation apparatus 202 are stored in different power storage units 109 in practice.

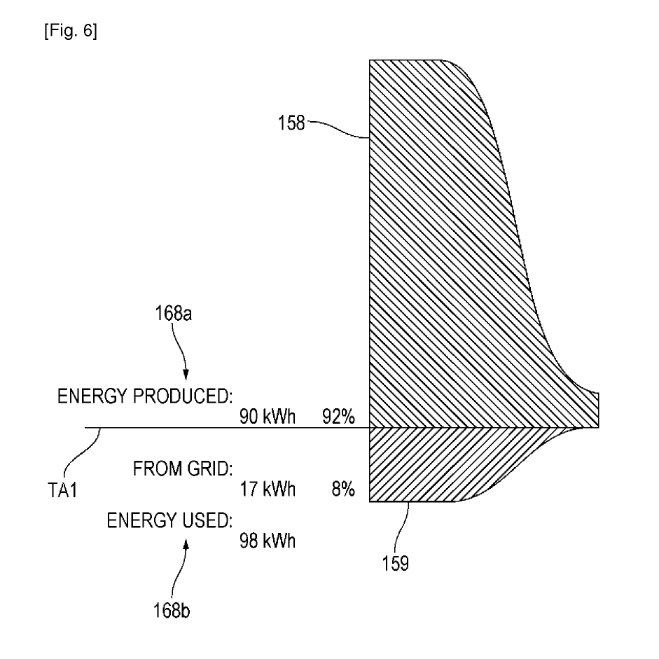

FIG. 6 is a diagram illustrating a portion in the vicinity of the mark 158 and the mark 159 included in the display 120 in an enlarged manner. As described above, the mark 158 corresponds to information representing an integrated value of power supply amounts for a certain period of time and is displayed in green, for example. The mark 159 corresponds to information representing an integrated value of power consumption amounts for the certain period of time and is displayed in red, for example. The certain period of time may be appropriately set such as past one week or a period of time from when the measurement is started to a current time. The certain period of time may be determined by the user.

The user may roughly recognize a sum of power supply amounts and a sum of power consumption amounts from a size of the mark 158 and a size of the mark 159, respectively. As illustrated in FIG. 6, text information 168a and text information 168b may be additionally displayed. The text information 168a is displayed on the upper side of the time axis TA1 and the text information 168b is displayed on the lower side of the time axis TA1.

The text information 168a includes a numerical value representing a sum of amounts of electric power supplied from the solar power generation apparatus 201 and the wind power generation apparatus 202 and a numerical value representing a ratio of a power supply amount to an entire amount (the power supply amount and an amount of consumption of electric power supplied from the grid 203). The text information 168b includes a numerical value representing an amount of consumption of electric power supplied from the grid 203 and a numerical value representing a ratio of an amount of consumption of electric power supplied from the grid 203 to the entire amount (the power supply amount and the amount of consumption of electric power supplied from the grid 203). The text information 168b further includes a numerical value representing an amount of consumption of electric power used by the loads in practice (irrespective of the supply source (the power storage device 107 or the grid 203)).

### 2. Second Embodiment

Next, a second embodiment will be described. A system configuration and a configuration of a display control device according to the second embodiment are substantially the same as those of the first embodiment, and therefore, only different points are mainly described.

A controller 101 of a display control device 100 has a function of recognizing an electronic apparatus which is connected to an outlet. For example, an ID (identification) specifying a type of an electronic apparatus is stored in an electric power plug of the electronic apparatus. When the electric power plug of the electronic apparatus is inserted into an outlet, an ID stored in the electric power plug is superposed on an electric power line and supplied to the controller 101. The controller 101 identifies the electronic apparatus in accordance with the supplied ID. The controller 101 supplies information on the identified electronic apparatus to a display controller 105. The display controller 105 may perform display in accordance with the information on the electronic apparatus supplied from the controller 101.

### Example of Display Based on Display Data

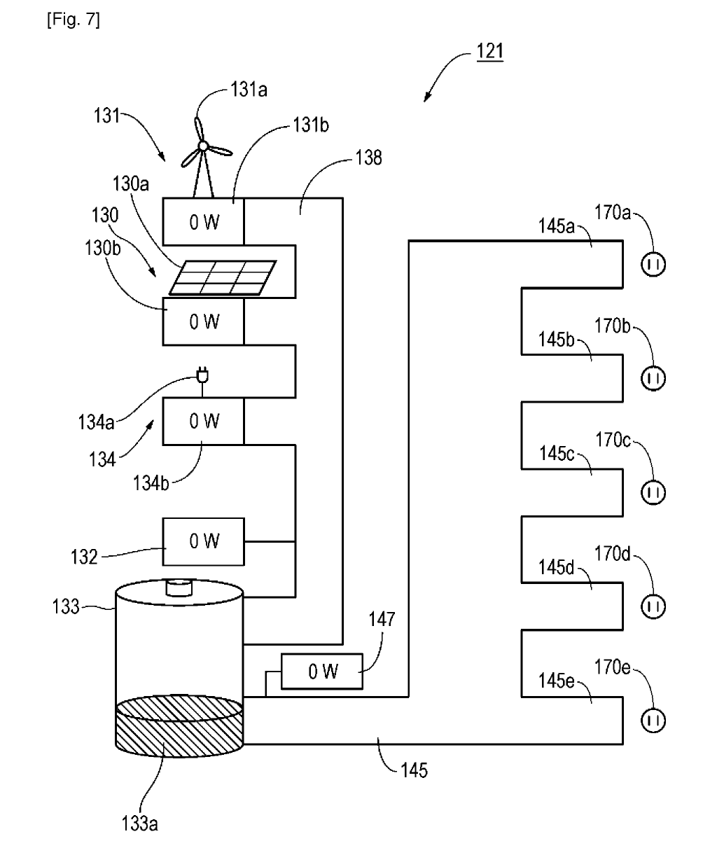

FIG. 7 is a diagram illustrating display 121 displayed under control of the display controller 105 according to the second embodiment. The display 121 is obtained by adding signs of loads to the display 120, for example. A power supply path 145 which extends from a battery mark 133 is divided into branches corresponding to a number of outlets. The power supply path 145 is divided into branches corresponding to five supply paths (power supply paths 145a to 145e), for example.

At ends of the power supply paths 145a to 145e, marks representing outlets are displayed. At an end of the power supply path 145a, a mark 170a representing an outlet is displayed. At an end of the power supply path 145b, a mark 170b representing an outlet is displayed. At an end of the power supply path 145c, a mark 170c representing an outlet is displayed. At an end of the power supply path 145d, a mark 170d representing an outlet is displayed. At an end of the power supply path 145e, a mark 170e representing an outlet is displayed.

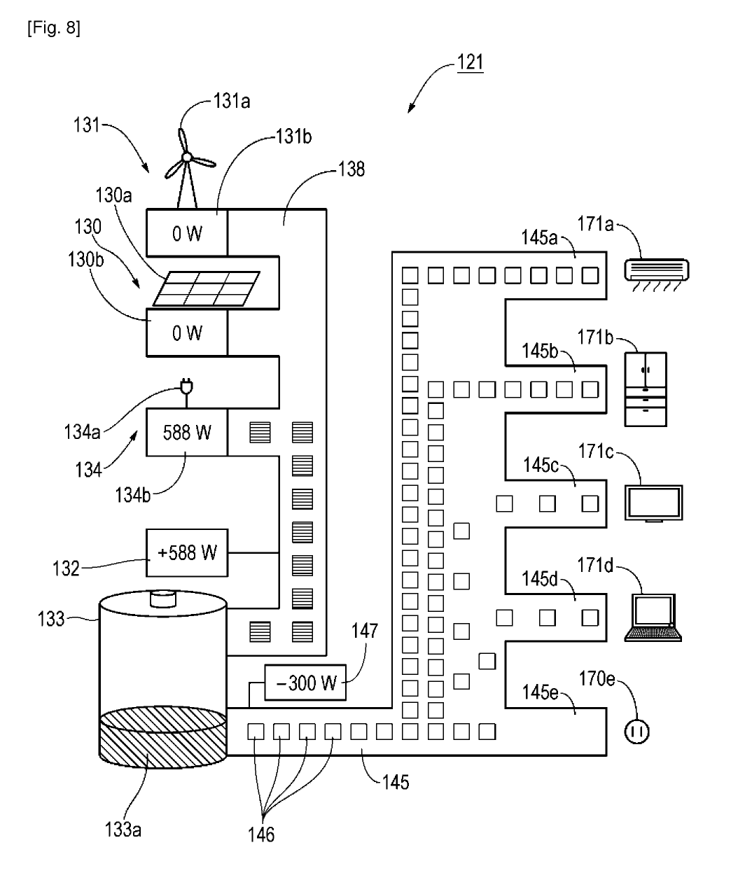

When the power supply plug of the electronic apparatus is connected to one of the outlets, a mark corresponding to the outlet is changed to a mark representing the electronic apparatus (a load) (an eighth mark). As illustrated in FIG. 8, when an air conditioner is connected to the outlet corresponding to the mark 170a, for example, the mark 170a changes to a mark 171a representing the air conditioner as illustrated in FIG. 8. When a refrigerator is connected to the outlet corresponding to the mark 170b, for example, the mark 170b changes to a mark 171b representing the refrigerator.

When a television set is connected to the outlet corresponding to the mark 170c, for example, the mark 170c changes to a mark 171c representing the television set. When a personal computer is connected to the outlet corresponding to the mark 170d, for example, the mark 170d changes to a mark 171d representing the personal computer. Note that the mark 170e is not changed since any electronic apparatus is not connected to the outlet corresponding to the outlet mark 170e.

A plurality of indication blocks 146 move from the battery mark 133 to the marks 171a to 170d. The larger power consumption of an electronic apparatus is, the higher a movement speed of the indication blocks 146 is. For example, power consumption of the air conditioner and the refrigerator is larger than that of the television set and the personal computer. Therefore, movement speeds of the indication blocks 146 which move toward the marks 171a and 171b are higher than movement speeds of the indication blocks 146 which move toward the marks 171c and 171d. The indication blocks 146 which move toward the marks of the different electronic apparatuses may be displayed in different colors and different shapes so as to be distinguished from one another.

The movement speeds of the indication blocks 146 may be constant, and as the power consumption of an electronic apparatus is large, the number of indication blocks 146 which move toward the mark of the electronic apparatus may become large. Specifically, intervals between the indication blocks 146 may be made small and the indication blocks 146 may be closely displayed. Display content illustrated in FIG. 8 may be displayed in the display unit 106 as the display 121.

### 3. Third Embodiment

Next, a third embodiment will be described. In the third embodiment, the display 120 or the display 121 is displayed in a mobile terminal 300.

### Configuration of Mobile Terminal

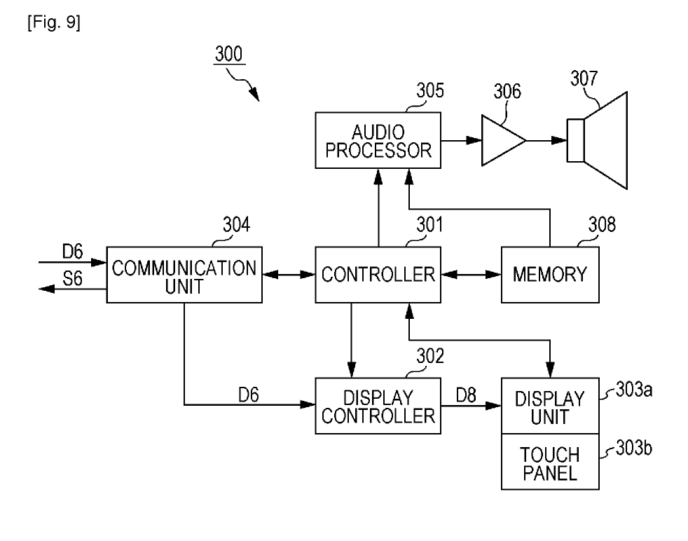

FIG. 9 is a diagram illustrating a configuration of a mobile terminal 300. The mobile terminal 300 includes a controller 301, a display controller 302, a display unit 303a, a communication unit 304, an audio processor 305, an amplifier 306, a speaker 307, and a memory 308, for example. The display unit 303a is configured as a touch panel 303b for operating the display unit 303a. Note that, in FIG. 9, flows of control signals and data are denoted by arrow marks of solid lines.

The controller 301 includes a CPU, for example, and controls the units of the mobile terminal 300. The display controller 302 has a function substantially the same as the function of the display controller 105 of the display control device 100. Specifically, the display controller 302 executes predetermined drawing software so that certain display is performed in accordance with data D6 received by the communication unit 304. When the display controller 302 operates, display data D8 is generated. The display data D8 is supplied to the display unit 303a which performs display in accordance with the display data D8. For example, the display 120 or the display 121 which is described hereinabove is displayed in the display unit 303a.

The display unit 303a includes an LCD panel or an organic EL panel. In the display unit 303a, the display 120 or the display 121 is displayed. The display unit 303a is configured as the capacitive touch panel 303b, for example. A resistive film type touch panel or an optical type touch panel may be used.

The communication unit 304 communicates with other apparatuses (such as the display control device 100). For example, a request signal S6 is transmitted from the mobile terminal 300 to the display control device 100 through the communication unit 304. In response to the request signal S6, the display control device 100 transmits data D6 to the communication unit 304. The communication unit 304 supplies data D6 to the display controller 302.

An application (program) used to execute a predetermined process may be downloaded from a certain website through the communication unit 304. For example, an application for displaying display 123 which will be described hereinafter in the display unit 303a may be downloaded.

The mobile terminal 300 has a function of reproducing audio data. The audio processor 305 performs various signal processes on audio data input to the audio processor 305. For example, audio data stored in the memory 308 is supplied to the audio processor 305. The audio processor 305 performs an FFT process, a digital filtering process, a de-interleaving process, a decoding process, a level control process, and a DAC (Digital to Analog Converter) process which converts a digital signal which has been subjected to the above processes into an analog signal, for example, on the audio data.

The amplifier 306 amplifies the audio data supplied from the audio processor 305 by a predetermined amplification factor. The amplifier 306 may be configured by a digital amplifier. The audio data amplified by the amplifier 306 is reproduced by the speaker 307.

The memory 308 is a nonvolatile memory, for example, and various programs and data are stored in the memory 308. For example, the memory 308 stores programs to be executed by the controller 301 and the display controller 302. The memory 308 may be used as a work memory when the processes are executed. Applications downloaded through the communication unit 304 may be stored in the memory 308. The memory 308 may be detachable from the mobile terminal 300. The memory 308 may store audio data and still image data.

Note that the configuration of the mobile terminal 300 described above is merely an example and the present disclosure is not limited to this. For example, the mobile terminal 300 may have an image pickup function and the like.

### Operation of Mobile Terminal

An example of operation of the mobile terminal 300 and an example of operation of the display control device 100 in accordance with the operation of the mobile terminal 300 will be described. For example, an operation is performed on the touch panel 303b so that an operation of requesting display of the display 120 is performed. An operation signal corresponding to this operation is supplied from the touch panel 303b to the controller 301. In response to the operation signal, the controller 301 generates the request signal S6. The request signal S6 is transmitted through the communication unit 304 to the controller 101 of the display control device 100. The request signal S6 is transmitted to the controller 101 by near field communication or communication through the Internet, for example.

The controller 101 transmits the data D6 to the mobile terminal 300 in response to the request signal S6. The data D6 is similar to the data D4, for example, and includes the power supply amount data D1′, the power supply amount data D2′, the power consumption amount data D3, and the remaining capacity data D5. The data D6 is periodically transmitted to the mobile terminal 300.

The communication unit 304 receives the data D6. The communication unit 304 supplies the received data D6 to the display controller 302. The display controller 302 operates such that display is performed in accordance with the data D6 and generates the display data D8. Display is performed in the display unit 303a in accordance with the display data D8.

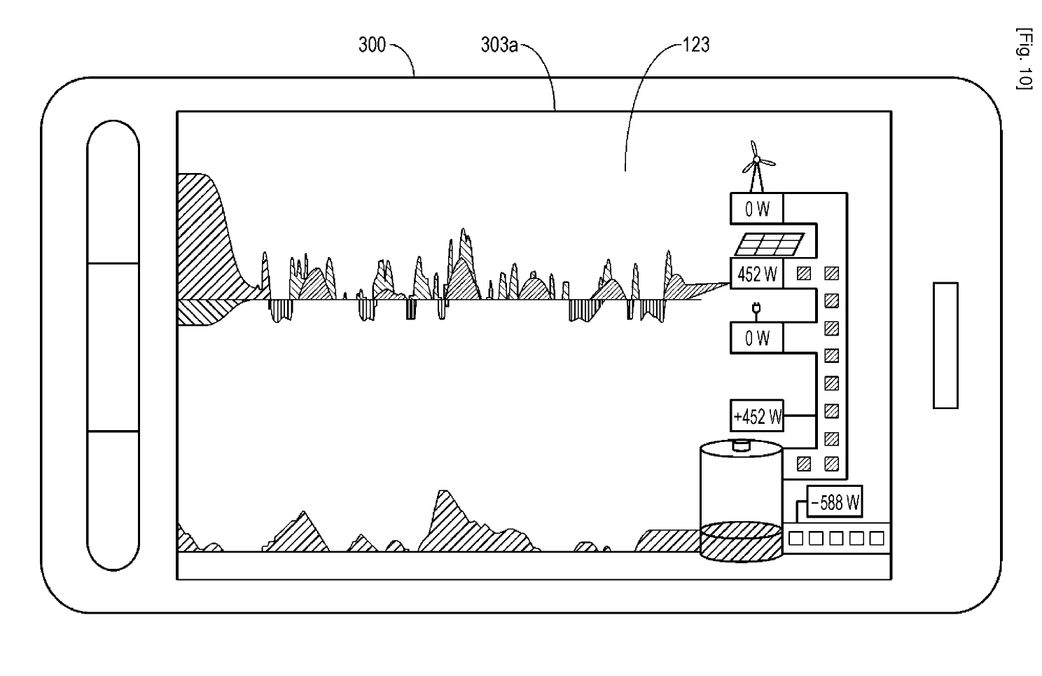

As illustrated in FIG. 10, the display 123 is displayed in the display unit 303a in accordance with the display data D8. The display 123 is the same as the display 120, for example. The display 123 may be obtained by simplifying the display content of the display 120 or by removing portions of the display content of the display 120. For example, the display 123 may be obtained by removing the marks 158 and 159 from the display 120. Content displayed in the display 123 may be appropriately set in accordance with a display region of the display unit 303a.

By displaying the display 123 in the display unit 303a of the mobile terminal 300, change of a power supply amount and change of an amount of consumption of electric power supplied from the grid 203 at home or in a company may be recognized even when a user is in outdoors.

### 4. Modifications

The embodiments of the present disclosure have been described hereinabove. However, the present disclosure is not limited to the foregoing embodiments and various modifications may be made.

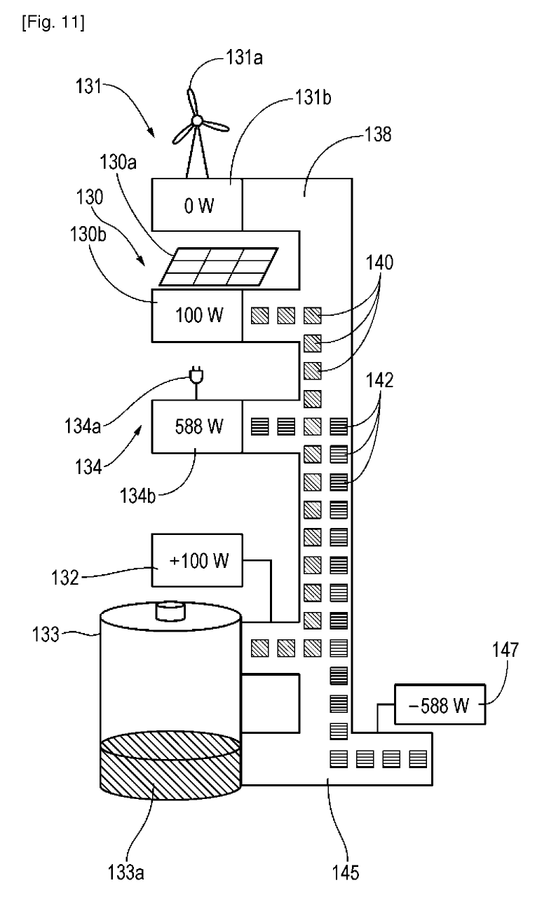

For example, as illustrated in FIG. 11, a route which does not pass through a battery mark 133 may be displayed. Indication blocks 142 may move in the route and directly move toward loads. Note that a display region 132 is displayed as if the display region 132 is connected to a route directing the battery mark 133. In this case, a sum of a numerical value displayed in a display region 130b and a numerical value displayed in a display region 131b is displayed in the display region 132.

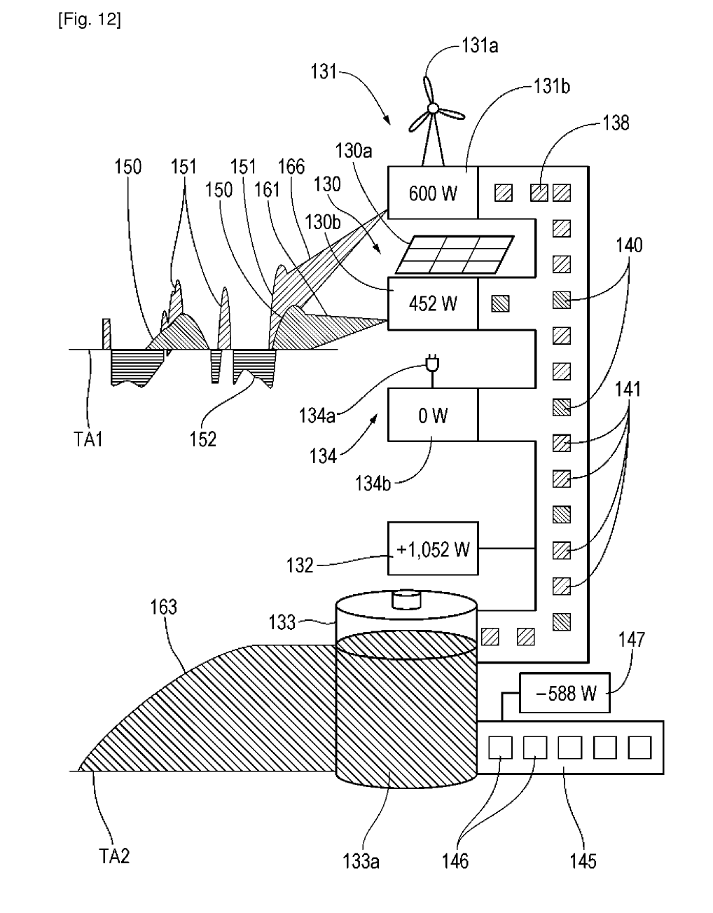

Indication blocks which line up may be moved. As illustrated in FIG. 12, indication blocks 140 and indication blocks 141 which line up together may move, for example. Colors of the indication blocks 140 and the indication blocks 141 may be gradually changed into green which is the same color as a remaining amount indicator 133a as the indication blocks 140 and the indication blocks 141 move close to the battery mark 133.

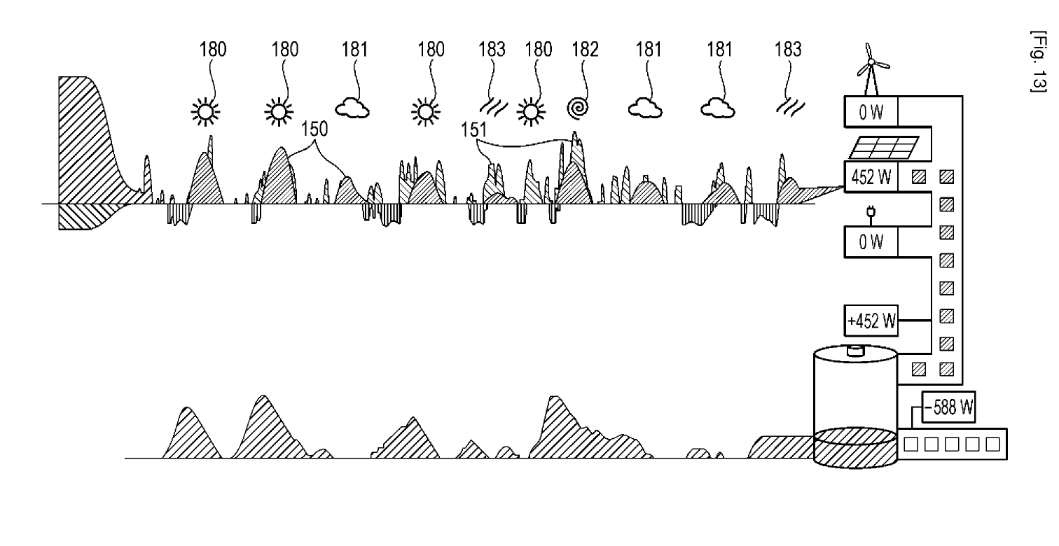

Marks representing weather may be displayed in accordance with sizes of marks 150 and 151 as illustrated in FIG. 13. For example, a mark 180 representing fair skies may be displayed over the marks 150 which have heights larger than a predetermined height. A mark 181 representing cloudy skies may be displayed over the marks 150 which have heights smaller than the predetermined height. The mark 181 may represent rain instead of cloudy skies. A tornado mark 182 representing a storm may be displayed over the marks 151 which have heights larger than a predetermined height. A mark 183 representing wind may be displayed over the marks 151 which have heights smaller than the predetermined height.

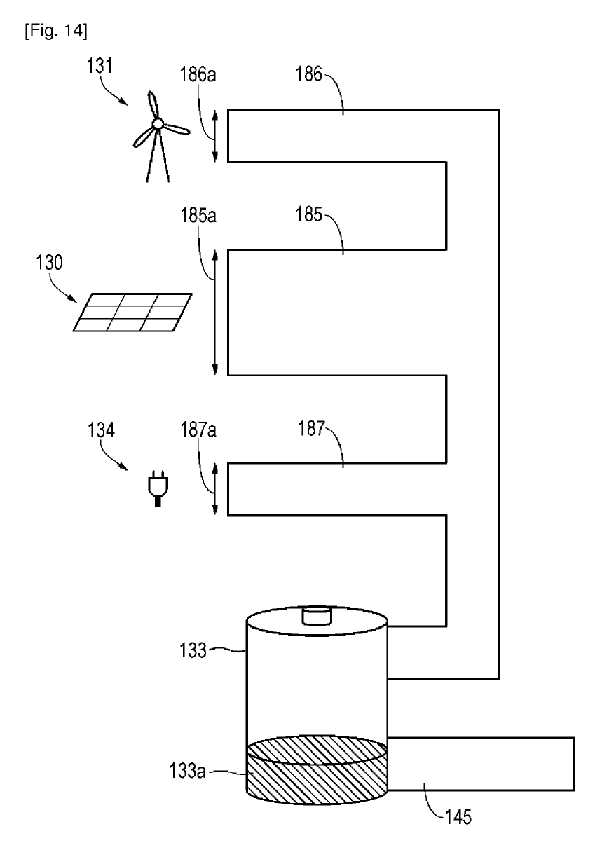

Part of the display content of the display 120 may be changed. For example, as illustrated in FIG. 14, a path 185 which extends from a solar power generation mark 130 is displayed. Furthermore, a path 186 which extends from a wind power generation mark 131 is displayed. The path 185 has a vertical width 185a. The path 186 has a vertical width 186a.

The widths 185a and 186a of the paths 185 and 186 are changed in accordance with corresponding power supply amounts. When an amount of electric power supplied from the solar power generation apparatus 201 is large, the width 185a is large. When the amount of electric power supplied from the solar power generation apparatus 201 is small, the width 185a is small. When an amount of electric power supplied from the wind power generation apparatus 202 is large, the width 186a is large. When the amount of electric power supplied from the wind power generation apparatus 202 is small, the width 186a is small. The change of the power supply amounts may be represented by change of the widths.

Furthermore, a path 187 which extends from a grid mark 134 may be displayed. The path 187 has a vertical width 187a. The width 187a of the path 187 is changed in accordance with the amount of consumption of electric power supplied from the grid 203. When the power consumption amount is large, the width 187a is large. When the power consumption amount is small, the width 187a is small. Change of the power consumption amount may be represented by change of the width.

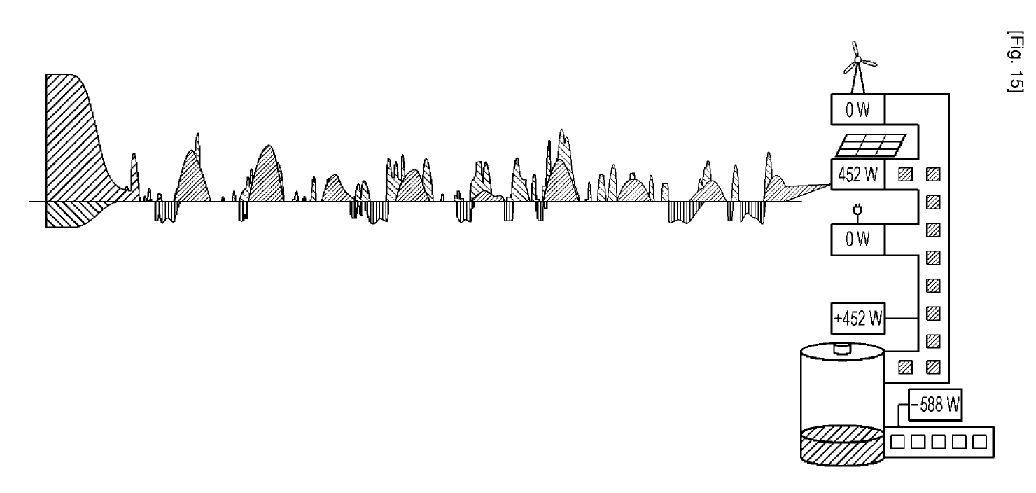

It is not necessarily the case that entire display content of the illustrated display 120 is displayed. For example, as illustrated in FIG. 15, the time axis TA2 and the marks 163 representing change of a remaining capacity which are included in the display 120 may not be displayed. Specifically, the present disclosure may be realized as a device which displays a portion of the display 120. Positions of the marks in the display 120 may be changed. For example, the solar power generation mark 130 and the battery mark 133 may be displayed on a left side in the display 120 and the marks 150 may move on the time axis TA1 from left to right.

The display data D7 may be stored. For example, the display data D7 obtained one month before may be stored so that the display 120 obtained one month before may be displayed. When past display 120 is displayed, a fast forward operation may be performed. Future prediction may be displayed in accordance with the past display data D7.

Colors of the remaining amount indicator 133a of the battery mark 133 may be changed in accordance with power supply sources. It is assumed that, in a remaining capacity of the power storage units 109, 70% of the remaining capacity is recharged by electric power supplied from the solar power generation apparatus 201 and 30% of the remaining capacity is recharged by electric power supplied from the wind power generation apparatus 202. In this case, approximately 70% of the remaining amount indicator 133a may be displayed in yellow and approximately 30% of the remaining amount indicator 133a may be displayed in blue. When the power storage units 109 are used, a yellow region and a blue region of the remaining amount indicator 133a may be equally reduced.

Furthermore, the present disclosure is not limited to an apparatus but may be realized as a method, a program, and a recording medium which records the program.

Note that the configurations and the processes in the foregoing embodiments and the modifications may be combined with one another as long as technical consistency is maintained. The order of the flows of the illustrated processes may be appropriately modified as long as technical consistency is maintained. The numerical values and the members in the foregoing embodiments and the modifications are merely examples and may be appropriately changed.

The present disclosure is applicable to a so-called cloud system in which the illustrated processes are processed by a plurality of apparatuses in a distributed manner. The present disclosure may be realized as an apparatus which has a system which executes the illustrated processes or which executes at least a number of the illustrated processes.

The present disclosure may be configured as below.

(1) A display control device including

a controller that obtains a power supply amount in accordance with an amount of electric power generated by a power generation unit, and

a display controller that displays a first mark representing the power generation unit and a second mark representing a power storage unit in a display unit and changes indications in a path displayed between the first and second marks in accordance with the power supply amount.

(2) The display control device according to (1), wherein the indications in the path include indication blocks which move toward the second mark from the first mark, and

the display controller displays the indication blocks such that a movement speed of the indication blocks becomes high as the power supply amount becomes large.

(3) The display control device according to (2), wherein the display controller displays a plurality of first marks corresponding to a plurality of power generation units, and displays different indication blocks which move toward the second mark from the first marks distinguishable.

(4) The display control device according (3), wherein the display controller displays the different indication blocks distinguishable at least using different colors or different shapes.

(5) The display control device according to (1), wherein the indications in the path includes a path which extends from the first mark and which has a width, and the display controller displays the path such that the width of the path becomes large as the power supply amount becomes large.

(6) The display control device according to any one of (1) to (5), wherein the display controller changes a display state of the first mark in accordance with the power supply amount.

(7) The display control device according to any one of (1) to (6), wherein the power generation unit generates electric power using surrounding energy.

(8) The display control device according to any one of (1) to (7), wherein the display controller displays a third mark representing a grid power in the display unit.

(9) The display control device according to (8), wherein the controller obtains an power consumption amount representing an amount of consumption of electric power supplied from the grid power, and

the display controller changes indications in a path between the second and third marks in accordance with the power consumption amount.

(10) The display control device according to (9), wherein the display controller displays a fourth mark representing the power supply amount and a fifth mark representing the power consumption amount distinguishable.

(11) The display control device according to (10), wherein the display controller displays the fourth and fifth marks on upper and lower sides of a time axis, respectively, such that the fourth and fifth marks move on the time axis as time advances.

(12) The display control device according to (11), wherein the display controller displays a sixth mark representing information on an integrated value of the power supply amounts for a predetermined period of time and a seventh mark representing information on an integrated value of the power consumption amounts for the predetermined period of time in portions in the vicinity of an end of the time axis.

(13) The display control device according to (12), wherein the display controller performs display such that the fourth mark which moves on the time axis is absorbed by the sixth mark and the fifth mark which moves on the time axis is absorbed by the seventh mark.

(14) The display control device according to any one of (10) to (13), wherein the display controller displays the fourth mark having a beam shape extending from the first mark toward a portion in the vicinity of an end of the time axis and the fifth mark having a beam shape extending from the third mark toward a portion in the vicinity of the end of the time axis.

(15) The display control device according to (1), wherein the display controller displays an eighth mark representing a load and changes indications in a path between the second mark and the eighth mark in accordance with power consumption of the load.

(16) A display control method including

obtaining a power supply amount in accordance with an amount of electric power generated by a power generation unit, and

displaying a first mark representing the power generation unit and a second mark representing a power storage unit in a display unit and changing indications in a path displayed between the first and second marks in accordance with the power supply amount.

(17) A program that causes a computer to execute a display control method of a display control device, the program including

obtaining a power supply amount in accordance with an amount of electric power generated by a power generation unit, and

displaying a first mark representing the power generation unit and a second mark representing a power storage unit in a display unit and changing indications in a path displayed between the first and second marks in accordance with the power supply amount.

(18) A mobile terminal including

an obtaining unit that obtains a power supply amount in accordance with an amount of electric power generated by a power generation unit, and

a display controller that displays a first mark representing the power generation unit and a second mark representing a power storage unit in a display unit and changes indications in a path displayed between the first and second marks in accordance with the obtained power supply amount.

The present disclosure may be configured as below.

(1) An apparatus including:

a control unit to control display of at least one first mark representing a power generating unit and a second mark representing a power storage unit and change of an indication display between the first mark and the second mark according to an amount of power supplied from the power generating unit to the power storage unit.

(2) The apparatus according to (1), wherein the indication display includes at least one indication block.

(3) The apparatus according to (2), wherein the change of the indication display includes movement of the indication block.

(4) The apparatus according to (3), wherein a speed of the movement of the indication block is according to the amount of power supplied.

(5) The apparatus according to (4), wherein the speed is increased when the amount of power supplied is increased and the speed is decreased when the amount of power supplied is decreased.

(6) The apparatus according to (3), wherein the movement of the indication block is from the first mark to the second mark according to the amount of power supplied.

(7) The apparatus according to (1), wherein the indication display includes a numerical value indicating the amount of power supplied.

(8) The apparatus according to (1), wherein the at least one first mark includes a plurality of first marks and indication displays corresponding respectively to the first marks are different from one another.

(9) The apparatus according to (1), wherein the change of the indication display includes change of at least one of color or shape.

(10) The apparatus according to (1), wherein the control unit controls the display of the first mark according to the amount of power supplied.

(11) The apparatus according to (1), wherein the control unit controls display of a third mark representing grid power, weather or an outlet.

(12) The apparatus according to (1), wherein the control unit controls display of a third mark representing an amount of power in accordance with time.

(13) The apparatus according to (12), wherein the third mark represents an amount of power generated or power consumed.

(14) The apparatus according to (1), wherein the control unit controls display of another indication display according to an amount of power consumed.

(15) The apparatus according to (1), wherein the control unit controls display of an indication of a total amount of at least one of power generated or power consumed.

(16) A method including:

controlling, by a processor, display of at least one first mark representing a power generating unit and a second mark representing a power storage unit and change of an indication display between the first mark and the second mark according to an amount of power supplied from the power generating unit to the power storage unit.

(17) A non-transitory recording medium recorded with a program executable by a computer, the program including:

controlling display of at least one first mark representing a power generating unit and a second mark representing a power storage unit and change of an indication display between the first mark and the second mark according to an amount of power supplied from the power generating unit to the power storage unit.

(18) An apparatus including:

a control unit to control display of at least one first mark representing a power storage unit and a second mark representing a power consumption unit and change of an indication display between the first mark and the second mark according to an amount of power from the power storage unit consumed by the power consumption unit.

(19) The apparatus according to (18), wherein the indication display includes at least one indication block.

(20) The apparatus according to (19), wherein the change of the indication display includes movement of the indication block.

(21) The apparatus according to (20), wherein a speed of the movement of the indication block is according to the amount of power consumed.

(22) The apparatus according to (21), wherein the speed is increased when the amount of power consumed is increased and the speed is decreased when the amount of power consumed is decreased.

(23) The apparatus according to (17), wherein the second mark is a mark representing an outlet.

(24) The apparatus according to (23), wherein the second mark is changed from the mark representing an outlet to a mark representing an electronic apparatus.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

1 System
100 Display Control Device
201 Solar Power Generation Apparatus
202 Wind Power Generation Apparatus
203 Grid
101 Controller
105 Display Controller
106 Display Unit
107 Power Storage Device
130 Solar Power Generation Mark
131 Wind Power Generation Mark
133 Battery Mark
134 Grid Mark
140, 141, 142, 146 Indication Blocks
150, 151, 158, 159 Mark
TA1 Time Axis
161 Sign of Beam Shape
171a Mark Representing Air Conditioner
171b Mark Representing Refrigerator
171c Mark Representing Television Set
171d Mark Representing Personal Computer
185, 186, 187 Path Having Width
300 Mobile Terminal
302 Display Controller
303a Display Unit

1. An apparatus comprising:
a control unit to control display of at least one first mark representing a power generating unit and a second mark representing a power storage unit and change of an indication display between the first mark and the second mark according to an amount of power supplied from the power generating unit to the power storage unit.

2. The apparatus of claim 1, wherein the indication display includes at least one indication block.

3. The apparatus of claim 2, wherein the change of the indication display includes movement of the indication block.

4. The apparatus of claim 3, wherein a speed of the movement of the indication block is according to the amount of power supplied.

5. The apparatus of claim 4, wherein the speed is increased when the amount of power supplied is increased and the speed is decreased when the amount of power supplied is decreased.

6. The apparatus of claim 1, wherein the indication display includes a numerical value indicating the amount of power supplied.

7. The apparatus of claim 1, wherein the at least one first mark includes a plurality of first marks and indication displays corresponding respectively to the first marks are different from one another.

8. The apparatus of claim 1, wherein the change of the indication display includes change of at least one of color or shape.

9. The apparatus of claim 1, wherein the control unit controls the display of the first mark according to the amount of power supplied.

10. The apparatus of claim 1, wherein the control unit controls display of a third mark representing grid power, weather or an outlet.

11. The apparatus of claim 1, wherein the control unit controls display of a third mark representing an amount of power in accordance with time.

12. The apparatus of claim 11, wherein the third mark represents an amount of power generated or power consumed.

13. The apparatus of claim 1, wherein the control unit controls display of another indication display according to an amount of power consumed.

14. The apparatus of claim 1, wherein the control unit controls display of an indication of a total amount of at least one of power generated or power consumed.

15. A method comprising:
controlling, by a processor, display of at least one first mark representing a power generating unit and a second mark representing a power storage unit and change of an indication display between the first mark and the second mark according to an amount of power supplied from the power generating unit to the power storage unit.

16. A non-transitory recording medium recorded with a program executable by a computer, the program comprising:
controlling display of at least one first mark representing a power generating unit and a second mark representing a power storage unit and change of an indication display between the first mark and the second mark according to an amount of power supplied from the power generating unit to the power storage unit.

17. An apparatus comprising:
a control unit to control display of at least one first mark representing a power storage unit and a second mark representing a power consumption unit and change of an indication display between the first mark and the second mark according to an amount of power from the power storage unit consumed by the power consumption unit.

18. The apparatus of claim 17, wherein the second mark is a mark representing an outlet.

19. The apparatus of claim 18, wherein the second mark is changed from the mark representing an outlet to a mark representing an electronic apparatus.
